(19) United States
(12) Patent Application Publication
(10) Pub. No.: US 2022/0083921 A1
(43) Pub. Date: Mar. 17, 2022

(54) GOLFCART AND GOLF COURSE CONTROL SYSTEM

(71) Applicant: CLE Golf Properties, LLC, Chardon, OH (US)

(72) Inventors: Mate John Brkic, Chardon, OH (US); Johnny Brkic, Chardon, OH (US); Gabe Brkic, Chardon, OH (US); Mike Mucciarone, Chardon, OH (US); Jason Yanchar, Chardon, OH (US); Andy Kuhar, Chardon, OH (US)

(21) Appl. No.: 17/476,837

(22) Filed: Sep. 16, 2021

Related U.S. Application Data
(60) Provisional application No. 63/079,226, filed on Sep. 16, 2020.

(51) Int. Cl. G06Q 10/02; B60R 25/33; B60R 25/24; G06Q 30/02

(52) U.S. Cl. CPC G06Q 10/02; B60R 25/33; H04W 4/80; G06Q 30/0241; B60R 25/24

(57) ABSTRACT

A golf course and vehicle administration system includes a player software application installed on a mobile device of a player, a central control system, and a vehicle control unit connected to a vehicle. The central control server communicates with the player software application over the internet. The vehicle control unit has a long-range wireless communication module to communicate with the central control system, a short-range wireless communication module to communicate with the player software, and a relay to activate the vehicle. The player software application sends a short-range wireless communication to the vehicle control unit that activates the vehicle. After activation of a vehicle, the player software application transmits confirmation of activation to the central control system to link the player with the vehicle.

### RELATED APPLICATIONS

The present application claims priority/benefit under 35 U.S.C. § 119(e) from U.S. provisional patent application No. 63/079,226 entitled GOLFCART CONTROL SYSTEM and filed on Sep. 16, 2020, the entire disclosure of which is incorporated herein by reference.

### TECHNICAL FIELD

The present invention relates generally to property and vehicle control and management systems, and in particular to systems for controlling and managing golf courses and golfcarts.

### BACKGROUND OF THE INVENTION

Golf course administration technology has remained relatively stagnant for decades. Many current courses use only a bare-bones software solution for general accounting, inventory and recordkeeping purposes. As such, a number of inefficiencies persist in golf course management that not only result in wasted time, money and resources for the golf course, but which also hurt players' experience on the course.

For example, it is currently difficult to track vehicles on the course. Typically, this is done by golf course employees inventorying vehicles periodically (e.g., at the close of the day). If vehicles are missing, then employees have the (often difficult) task of roaming the course looking for them. In some areas, theft of vehicles is a serious problem. Damage to vehicles is also frequent. While some courses have a manual check-in process for vehicles (and for players generally), it is often difficult to know who is actually using a vehicle at any given time and who may have caused damage and/or lost the vehicle. Moreover, the check-in process can be time consuming for the player, requiring checking and keeping identification, and the process creates unnecessary points of physical contact, which are of increasing concern in the pandemic era.

The lack of awareness of vehicle location causes many other downstream inefficiencies. For example, the golf course administrators cannot track the pace of play, which precludes the golf course from scheduling tee times to maximize player throughput. It also prevents the golf course from monitoring congestion so as to provide deals or incentives in real time when the course has available bandwidth. It is also nearly impossible to schedule players for any number of holes other than the standard full (eighteen) or half (nine) because there is no way to track how many holes a given player has played.

The lack of cohesion between the golf course administrative apparatus and the players also results in a lower player experience. For example, it is difficult for players to find available tee times and play a non-conventional number of holes. Players also do not have the convenience of quick contactless check-in and vehicle procurement and cannot order food, beverages or products to be ready at a particular tee time or delivered on the course. Current systems also cannot track player behaviors and preferences and also lack any social experience that allows players to connect to one another, share and review statistics or organize tournaments.

There is thus a need for new systems to manage golf courses more holistically and address administrative and player experience issues. Foremost, there is a need for a system that can more efficiently synchronize players with vehicles to speed up the check-in process and allow the golf course administrators to track vehicles. There is further need for a system that better allows players to find and book tee times, order products for use at a particular tee time and store and share user data for a more cost-effective and efficient user experience.

### SUMMARY OF THE INVENTION

According to one aspect of the invention, a golf course and vehicle administration system includes a player software application installed on a mobile device of a player. The system also includes a central control system having a central control server, at least one database with golf course, vehicle and player information stored thereupon, and a first long-range wireless communication module. The central control server is in data communication with the player soft-ware application via the mobile device over the internet. The system further includes a vehicle control unit connected to a vehicle, the vehicle control unit having a second long-range wireless communication module configured to communicate with the central control system, a short-range wireless communication module configured to communicate with the player software via the mobile device, and a relay configured to activate the vehicle. The player software application is configured to send a short-range wireless communication to the vehicle control unit that activates the vehicle, The player software application is configured to, after activation of a vehicle, transmit confirmation of the activation to the central control system to link the play-er with the vehicle.

According to another aspect of the invention, a method for controlling a vehicle on a golf course includes connecting a vehicle control unit to the vehicle, the vehicle control unit having a long-range wireless communication module configured to communicate with a central control system, a short-range wireless communication module configured to communicate with a player software application installed on a mobile device, and a relay configured to activate the vehicle. The method further includes receiving, from the player software, via short-range wireless communication, a re-quest to activate the vehicle, and in response to the request, controlling the relay to activate the vehicle, transmitting, to the central control system, via long-range wireless communication, data indicating that the vehicle has been activated.

According to a further aspect of the invention, a method of managing a golf course and vehicles therein includes receiving, via the internet, and from a player software application installed on a mobile device of a player: a request to register the player, a request to book a specific tee time, and a request to check in for the specific tee time. The method further includes transmitting, via the internet, and to the player software application, an instruction to activate a specific vehicle on the golf course, and receiving, via long-range wireless communication, from a vehicle control until connected to the vehicle, confirmation that the vehicle was activated;

### BRIEF DESCRIPTION OF THE DRAWINGS

FIG. 1 shows a high-level schematic diagram of an exemplary golf course and vehicle management system as described herein;

FIG. 2 shows an exemplary vehicle having a specialized vehicle as described herein;

FIG. 3 depicts a photograph of an exemplary vehicle control unit.

FIG. 4 shows a schematic diagram of an exemplary central control system for a golf course and vehicle management system as described herein;

FIGS. 5-10 depict exemplary schematic diagrams for various user interfaces of a central control system as described herein.

FIG. 6a is a screenshot of one exemplary user interface of a central control system as described herein.

FIG. 11 shows a flow diagram of an exemplary player software for a golf course and vehicle management system as described herein;

FIG. 12 shows an exemplary sub-process of player software for synchronizing a vehicle with a player.

FIG. 13 shows a flow diagram of another exemplary player software for a golf course and vehicle management system as described herein;

### DETAILED DESCRIPTION

The present invention provides several benefits over existing systems and methods for managing and controlling golf courses and golfcarts. For example, it will streamline the golf course check-in process and allow users to spend more time on a golf course. It will allow golf course owners to have better tracking and accountability of the golfcarts' whereabouts. It will make golf more social, with the ability to share information among users. The invention will allow golf course owners to make more money by communicating with golfers on the course to track and obtain data on spending, planned play, etc. It will also allow golfers to play less than a typical set of holes (9, 18), as position tracking can automatically bill their account depending on how many holes the cart tracked, thus speeding up play and allowing for more play.

The embodiments disclosed herein will now be described by reference to some more detailed embodiments, with occasional reference to the accompanying drawings. These embodiments may, however, be embodied in different forms and should not be construed as limited to the embodiments set forth herein. Rather, these embodiments are provided so that this disclosure will be thorough and complete, and will fully convey the scope of the embodiments to those skilled in the art.

Unless otherwise defined, all technical and scientific terms used herein have the same meaning as commonly understood by one of ordinary skill in the art to which these embodiments belong. The terminology used in the description herein is for describing particular embodiments only and is not intended to be limiting of the embodiments. As used in the specification, the singular forms “a,” “an,” and “the” are intended to include the plural forms as well, unless the context clearly indicates otherwise.

The following are definitions of exemplary terms used throughout the disclosure. Both singular and plural forms of all terms fall within each meaning:

“Software” or “computer program” as used herein includes, but is not limited to, one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

“Mobile Device” as used herein, includes, but is not limited to, smart phones, tablets, laptop computers and other mobile devices. Typically, these devices access the internet or intranet or cellular or wireless fidelity (Wi-Fi) networks, to access, retrieve, transmit and share data.

“Computer” or “processor” as used herein includes, but is not limited to, any programmed or programmable electronic device that can store, retrieve, and process data.

At a high level, the disclosed system includes a collection of discrete components in a distributed architecture, each performing different functions designed to assist in the day-to-day operations of golf course management and to enhance the experience of golfers. More importantly, the present system solves a number of problems with, and provides a number of new benefits over, existing technologies.

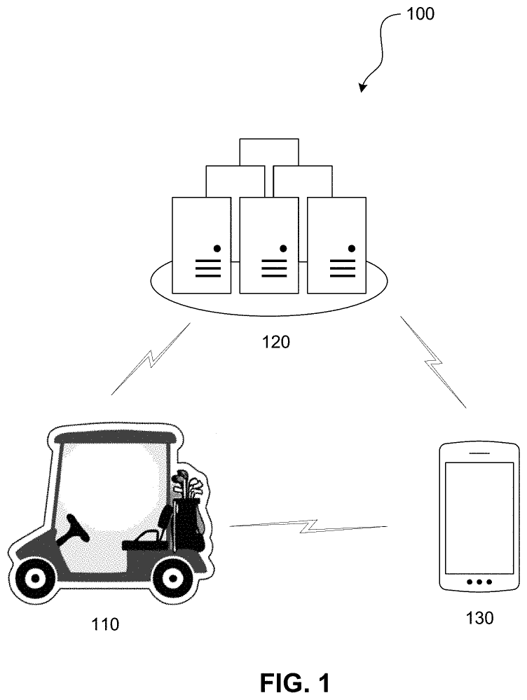

As depicted in FIG. 1, an exemplary golf course control system 100, at a very high level, includes one or more vehicles 110, a central control system 120 and player software 130 operating on a mobile device. Each of these high-level components is discussed in detail below. Moreover, each of the high-level components are in data communication with each other as described below. As a result of the separation of functionalities explained herein between these three components, it is possible to both enhance player experience and ease administrative burdens.

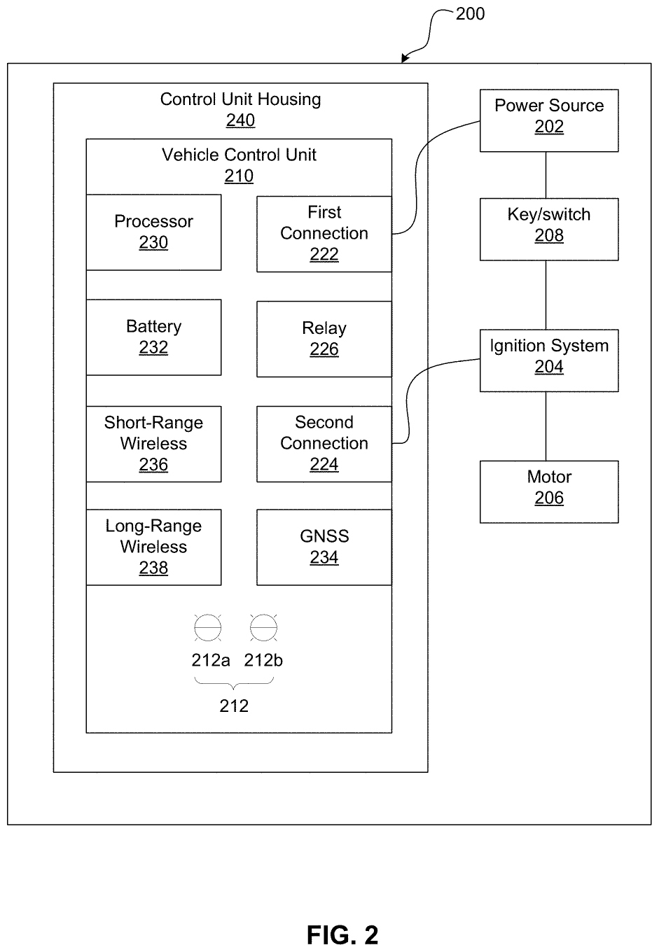

FIG. 2 illustrates an exemplary vehicle 200 having a vehicle control unit 210. While the present system is generally described with the vehicle 200 being a golfcart, it should be understood that other motorized vehicles may be used in the present system, including motorized scooters, motorized skateboards, motorized bicycles, all-terrain vehicles (ATVs), and the like. In one embodiment, the vehicle includes a power source 202, ignition system 204, a motor 206, and a key and/or switch 208. The power source 202 may be any known vehicle power source, such a lead-acid or lithium-ion battery. The ignition system 204 is a known ignition system of a vehicle, which may be be mechanical or electric depending on the type of vehicle/motor. The motor 206 may be electric or combustion, or any other known technology. The key/switch 208 is generally installed in a vehicle between the power source 202 and ignition system to control whether the vehicle is on and motor 206 is active or not.

The vehicle control unit 210 is a specialized hardware unit designed to integrate into an existing vehicle (or be built into a vehicle) to provide additional functionalities including external communication and control from multiple sources. For example, the vehicle control unit 210 allows a player (or golf course administrator) to turn the vehicle 200 on or off remotely using software on a mobile device or through a remote terminal. The vehicle control unit 210 also allows golf course administrators to track the location of the vehicle and monitor other vehicle statistics. Administrators also have a “kill switch” ability to disable vehicles remotely in case of theft or other unauthorized use (e.g., a player playing more holes than purchased).

In one embodiment, the vehicle control unit 210 is housed within a weatherproof housing 240 (e.g. having at least a National Electronic Manufacturers Association rating of NEMA 4 or an ingress protection rating of IP64), and mounted within the vehicle 200, for example, in the dashboard. In some embodiments, the weatherproof housing 240 may be mounted externally on the vehicle 200.

The vehicle control unit 210 may include an on/off switch (not shown), accessible through the housing 240, which may be digital or analog, and may be a flip switch, button, rotary switch or the like. The on/off switch may provide for a “hard” off state that prevents any of the other functionalities described below unless the switch is in the on position. The vehicle control unit 210 also may include one or more indicators 212. In the embodiment shown, there are two indicator lights 212a and 212b. In other embodiments there may be one or more lights, or digital or analog displays. The indicators may be used to communicate the state of the control unit 210. For example, in one embodiment, the indicator light 212a may illuminate to indicate that the vehicle control unit 210 is powered on and ready to use, and the indicator light 212b may illuminate to communicate that a user has successfully connected to the vehicle control unit 210 as described more fully below.

The vehicle control unit 210 includes a first power connection 222 coupled to the power source 202 of the vehicle, and a second power connection 224 coupled to the ignition system 204 or drive mechanism (e.g., motor 206), or digital controller of the vehicle 200, such that the vehicle control unit 210 can turn the motor 206 on or off via relay 226. In some embodiments, the vehicle control unit 220 (through first and second connections 222 and 224) is connected in parallel to an existing connection between the power source 202 and ignition system 204 using wires disposed through the housing 240. As such, the vehicle can be operated through either the key/switch 208 or the vehicle control unit 210. In other embodiments the vehicle control unit 210 is connected in series with (or replacing) the key/switch 208 such that the vehicle can only be operated through the vehicle control unit 210.

The vehicle control unit 210 contains a processor or microcontroller 230, which may include or be connected to data storage such as a cache, random access or other volatile memory, and non-volatile memory. The processor controls the functionalities of the vehicle control unit 210 through embedded firmware or software. The vehicle control unit also includes an integrated energy storage 232 (e.g., a rechargeable or other battery) that provides power to the unit. In some embodiments, the vehicle control unit 210 is powered using the power source 202 through the first connection 222, which also charges the integrated energy storage 232, and the integrated energy storage 220 is only used as a power source when no power is supplied from the vehicle's power source 202 (i.e., when the vehicle 200 is off). In other embodiments, the vehicle control unit 210 is powered by a combination of the integrated energy storage 232 and vehicle power source 202.

The vehicle control unit 210 also includes global navigation satellite system hardware (GNSS) 234, such as GPS, which provides a geolocational position of vehicle control unit 210 (and thus of the vehicle 200). The processor 230 (and associated memory) may store location and time data which, as described more fully below, may be used to determine when the vehicle control unit 210 communicates with other components of the golf course and vehicle control system.

The vehicle control unit 210 further includes short-range wireless communication hardware 236, such as Bluetooth, Wi-Fi or near field communication (NFC). The short-range wireless communication hardware 236 is designed for communication with player mobile devices as discussed more fully below. The vehicle control unit 210 also includes long-range wireless communication hardware 238, such as LoRa Wide Area Network (LoRaWAN), Long Term Evolution for Machines (LTE-M) or Narrow Band IoT (NB-IoT). The long-range wireless communication hardware 238 is designed for communication with the central control system as discussed more fully below.

One contemplated method of communicating between the vehicle control unit 210 and the central control system includes periodic, unsolicited reporting by the vehicle control unit 210 (e.g., every 60, 30, 15, 10 or 5 seconds). In another method, the central control system periodically polls the vehicle control unit 210 for updated information (e.g., every 60, 30, 15, 10 or 5 seconds), and the vehicle control unit 210 may always respond with current information, or respond only if it has information to report that is different from the prior communication.

It has been found that both of the above communication methods have drawbacks. If the time between communications is too long, the central control system (or vehicle) may miss critical information during the interim. On the other hand, too-frequent communication will drain the energy storage of the vehicle control unit 210 (and perhaps even the power source 202 of the vehicle 200). Moreover, in a system with a large number of vehicles, too-frequent communication can overburden the central control system and clog up limited bandwidth over the long-range wireless communication network. As such, it has been found that a preferred method of communication involves the vehicle control unit 210 using a combination of time (from a timer of the processor 230) and position (from the GNSS 234) to selectively determine whether to send updated information to the central control system For example, in one embodiment, the vehicle control unit 210 will send updated information within 60 seconds (1 minute) if vehicle 200 has moved more than 50 meters since its last-transmitted position. If the vehicle 200 has not moved 50 meters from its last-reported position, the vehicle control unit 210 will wait 600 seconds (10 minutes) before sending an update. Accordingly, each vehicle control unit 210 conserves power and network resources by only reporting position information an update is needed due to a change in position and when it is thus useful to the system.

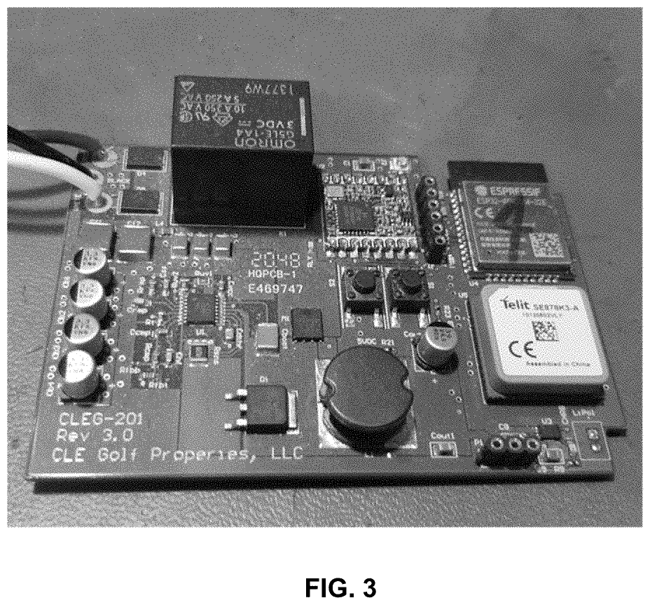

FIG. 3 depicts an image of an actual, fully-built exemplary vehicle control unit 300 similar to the exemplary vehicle control unit 210 discussed above. Though not shown, it is also contemplated that the vehicle control unit may have additional components and functionalities. For example, the vehicle control unit may have motion-sensing hardware, such a gyroscopes and/or accelerometers, which can measure speed and detect collisions and rollovers of the vehicle. The vehicle control unit may also have additional connections to hardware and components of the vehicle to obtain vehicle statistics. For example, the vehicle control unit may interface with the vehicle to obtain and report fuel levels, oil levels, battery levels, tire pressure levels, mileage, diagnostics, speed, and more.

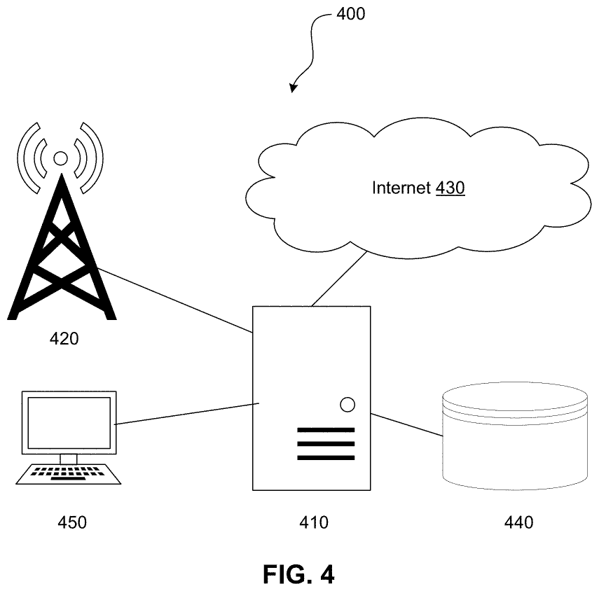

Turning to a different component of the system, FIG. 4 depicts an exemplary central control system 400. The central control system 400 includes a control server 410 that acts as the brain for entire system and performs many functions. For example, the control server 410 communicates with and tracks vehicles on the golf course using the long-range wireless communication hardware 420, which is preferably the same type/protocol of long-range wireless communication hardware described above for use in the vehicle control unit 210. The control server 410 can be used to instruct a vehicle control unit to turn a vehicle on or off. Information obtained from the vehicle may be processed by the control server 410 to determine a player's pace of play, optimize scheduling, extrapolate player habits and provide targeted discounts and incentives.

The control server 410 also communicates with player software on mobile devices through the internet 430 to: collect player information; allow players to schedule tee times and place food and product orders; provide deals, incentives and other information to players; and provide players access to vehicles. The functionalities of the player software are described more fully below.

The central control system also includes one or more database(s) 440. The database 440 houses the data used in the system, including player profiles and course and cart historical records. While the central control system 400 depicts the database 440 at the same location as the control server 410, it should be understood that either (or both) of the control server 410 and database 440 may be located elsewhere (for example on web or cloud servers), and accessed at the golf course through the internet 430.

The central control system 400 may also includes one or more terminal(s) 450. The terminal 450 provides an access point to the central server 410 and allows a golf course administrator to view and change player, course and vehicle information, communicate with players and to turn vehicles on or off. In some embodiments the terminal 450 can be a remote computer or mobile device that accesses the central server 410 through an administrator mode of the player software described below.

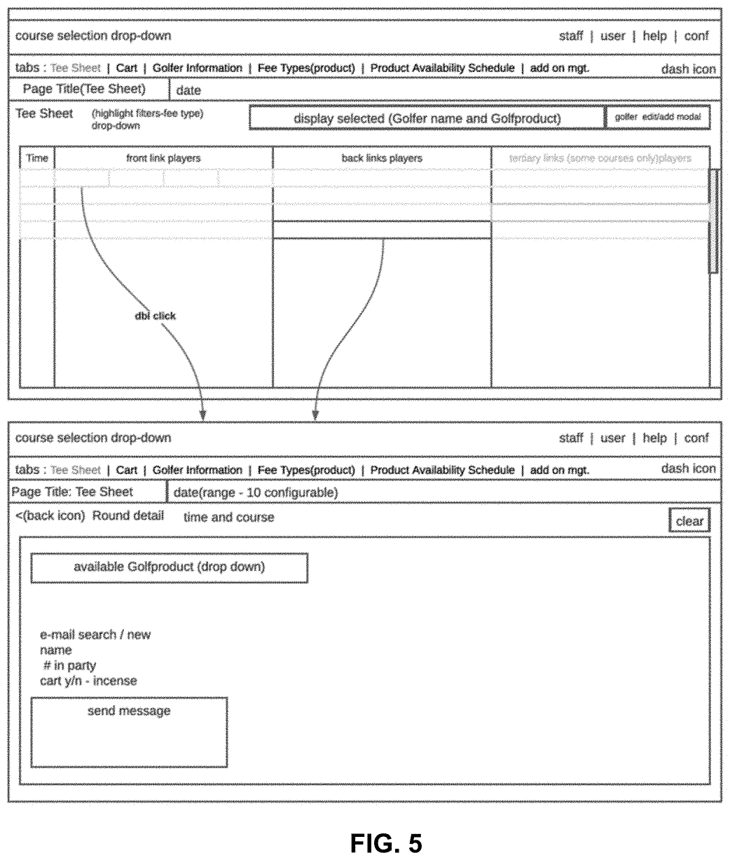

The varied functionalities of the central control system 400 are described with reference to a number of exemplary schematic diagrams of user interfaces for the system. FIG. 5 depicts an exemplary “tee sheet” interface screen. On this screen, an administrator can view and edit the course schedule and player information. Specifically, the “tee sheet” interface screen includes tee times, booking player names and other/guest player names, separated by course segment being played (front nine, back nine, other set). The administrator can drill down into the data on a player to view further information about them and contact them through a message that the player will receive in the player software.

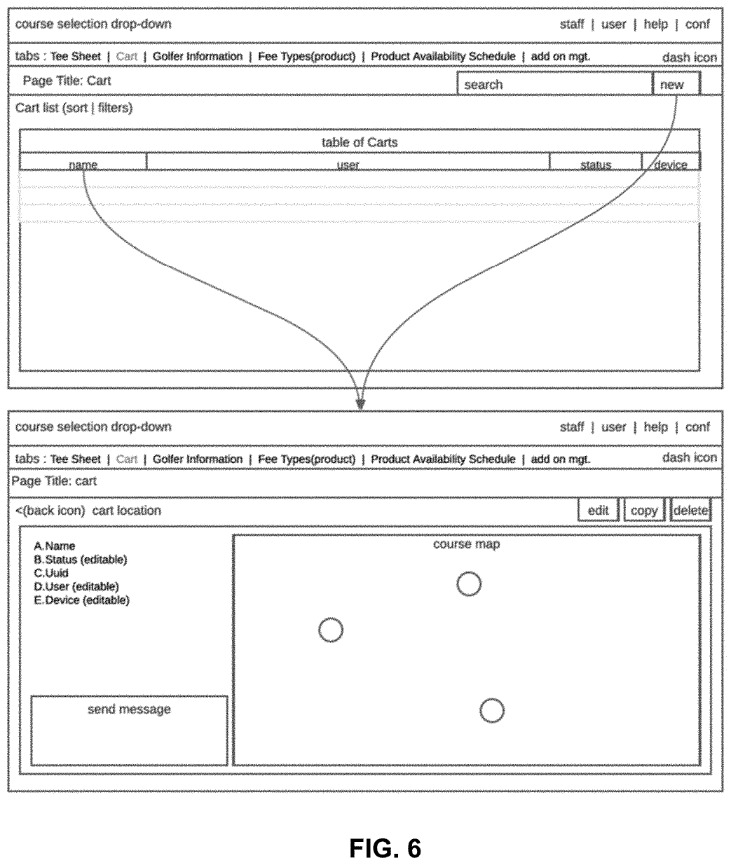

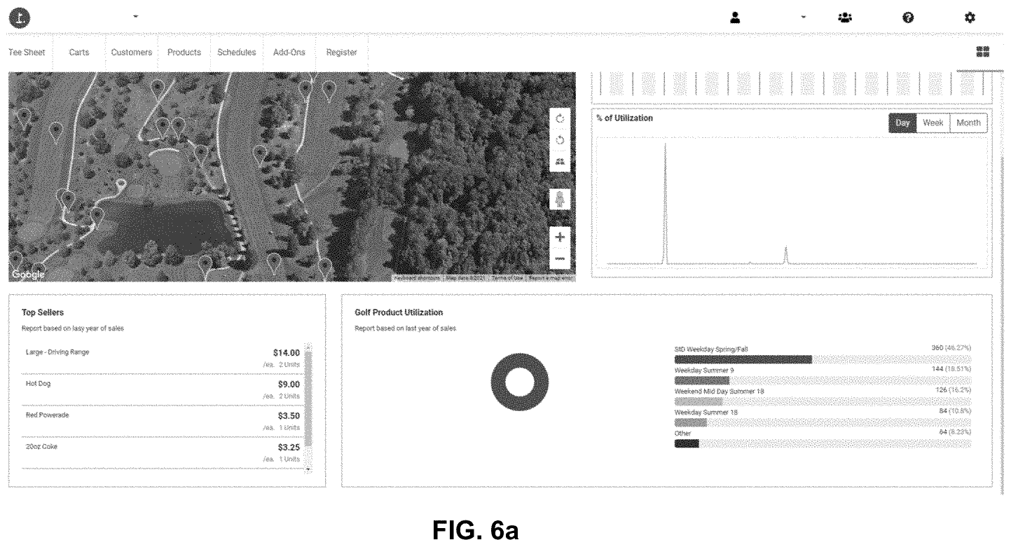

FIG. 6 illustrates an exemplary “cart” interface screen. On this screen, an administrator can view a list of vehicles registered for the course and can see which player(s) are using each one, and what the status of the vehicle is. Drilling down on the cart interface screen will allow the administrator to view a map of the golf course showing locations for any vehicles and allow the administrator to assign vehicles to players, turn vehicles on or off, and send messages to players. As explained previously, the map is populated from data periodically sent front each vehicle to the central control system 400 via long-range wireless communication hardware 420. As such, if a vehicle has not reported any information for some time, the map will show the vehicle's last-reported position. The cart interface screen may also show the time of each vehicle's last-reported data.

FIG. 6a shows an exemplary screenshot of a user interface of the type described above for FIG. 6. As seen in FIG. 6a, the user interface includes a map of the golf course with pins denoting the location of different vehicles on the golf course. Clicking on the pins will provide information about the player that is linked with the specific vehicle. The exemplary user interface of FIG. 6a also includes statistics such as golf product utilization (golf products are described below) as well as ancillary product sales information.

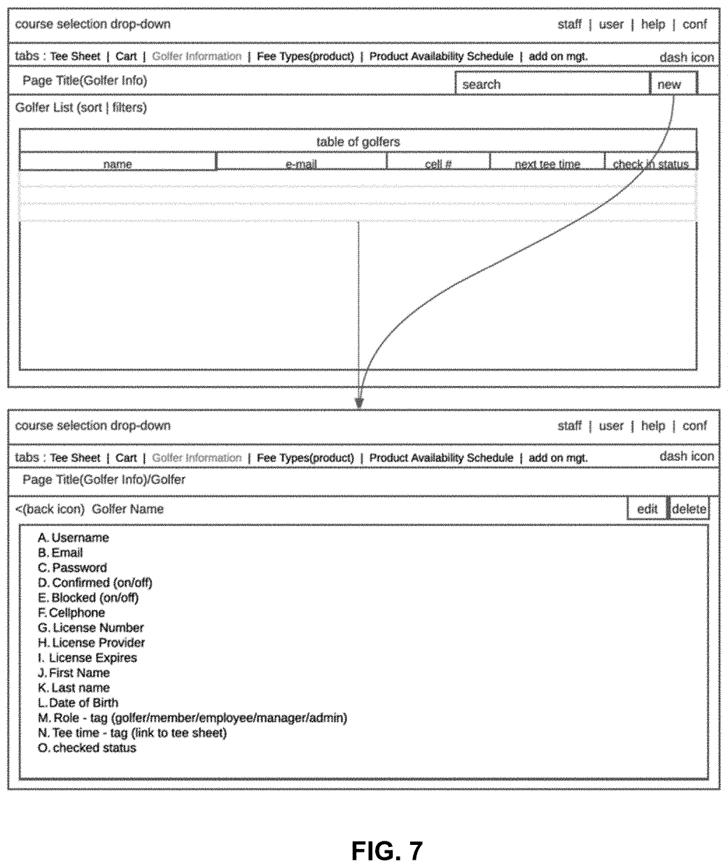

FIG. 7 depicts an exemplary “golfer info” interface screen that provides detailed information about players, such as personal information, contact information, tee times and on-course status. Drilling down into the data on players allows the administrator to edit this information.

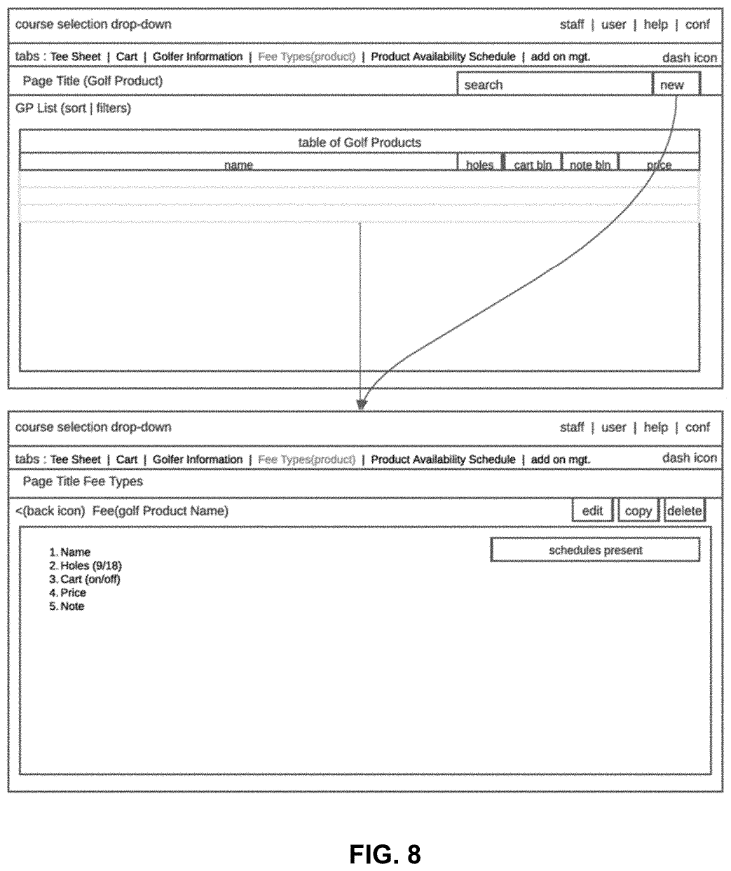

FIG. 8 depicts an exemplary “golf product” interface screen that allows an administrator to view edit details and pricing for different types of play packages available for purchase by players when booking tee times. For example, an administrator may set different pricing, scheduling restrictions, hole numbers, player group numbers, vehicle inclusion or other parameters based on time of year day of week, or player type (senior, youth, league, etc.).

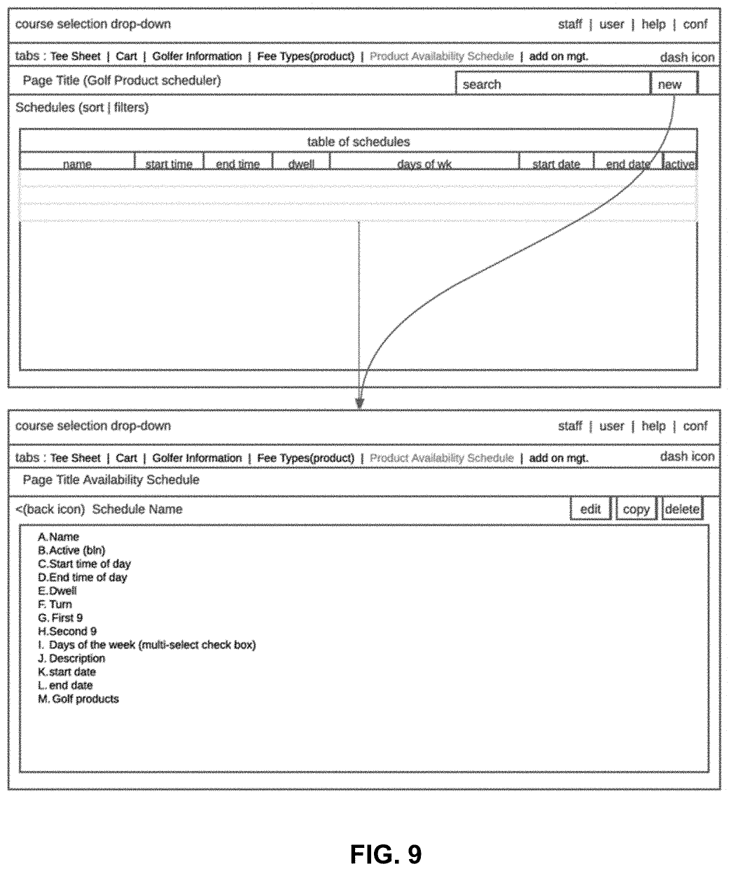

FIG. 9 depicts an exemplary “golf product scheduler” interface screen that allows an administrator to view and edit, via scheduling, when the different golf products described above are available. For example, an administrator can set the duration between tee times based on season, day of week or for a specific day, which will restrict what times are available for players to book as described more fully below. An administrator can also provide an estimated time for a player to make the turn (i.e., play 9 holes) to assist in scheduling tee times and preparing food and beverages, and as a measure for tracking pace of play.

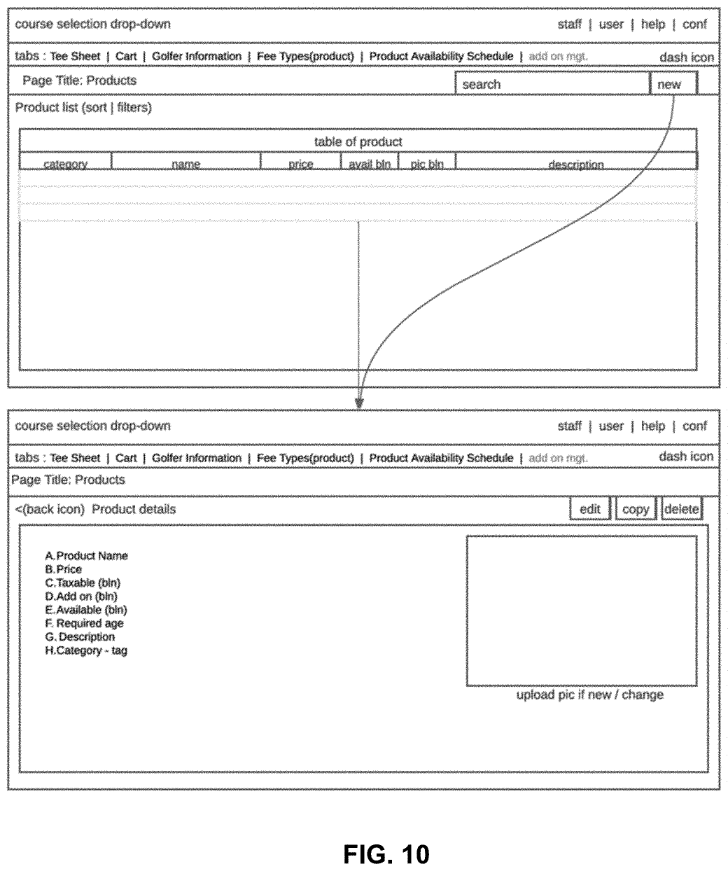

FIG. 10 depicts an exemplary “golf product scheduler” interface screen that allows an administrator to view and edit information about products and orders. For example, an administrator can view and edit product inventory and pricing, and edit details (like a product's description) that a player would see when purchasing the product.

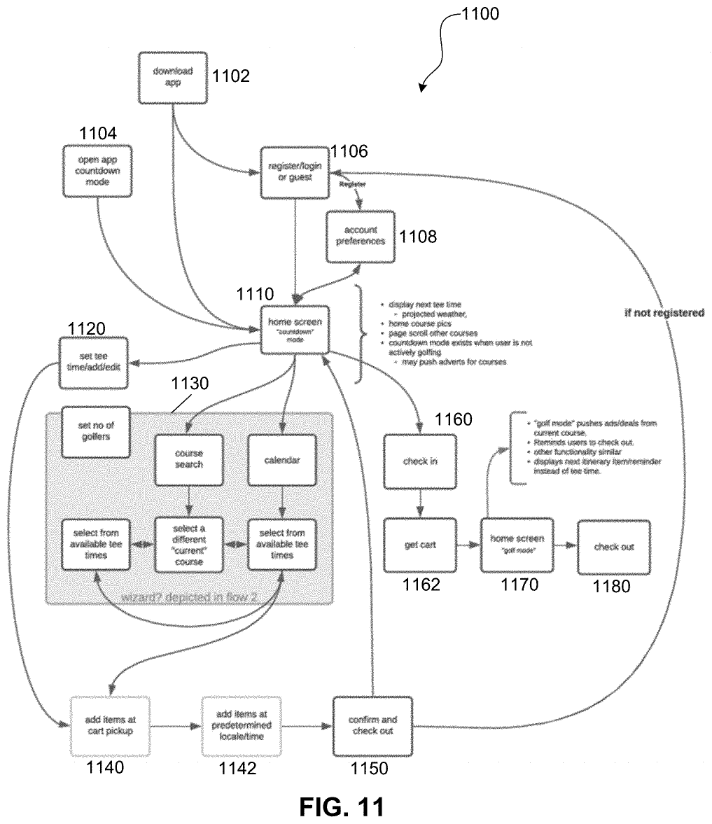

Turning now to the third major component of the system, FIG. 11 illustrates a flow diagram for an exemplary player software 1100 according to the present system. The exemplary player software 1100 generally includes the following features. It will allow golfers to use a mobile device (or personal computer) to check-in for a round of golf with no interaction at the pro shop. It will coordinate with the central control system to communicate with a vehicle and allow the player to turn the vehicle on. The player software 1100 will allow the player to create an account, save player personal information (e.g., driver's license number, payment information, etc.). The player software 1100 may have different versions for different client devices, for example, one version that is a downloadable mobile-device application and another version that is a web-based application accessible through a web browser of a personal computer or mobile device.

The general flow of the exemplary player software 1100 is as follows. At step 1102, a player downloads the player software 1100 as an application to their mobile device. Alternatively, at 1104, if the application is already downloaded, the player simply opens the application on their mobile device. At step 1106, the player is presented with a splash screen, which may contain the system owner/administrator's logo and any related trademarks, and wherein the player may login with existing credentials, register with the system to gain login credentials, or login as a guest.

If the player elects to register then at step 1108, the player creates an account and receives login credentials. At step 1108 the player may enter personal information such as name, address, phone number and email address. The player may also add driver license information and/or upload a license image. The player can also create a username and password and enter payment information to be used for scheduling tee times and making purchases. The player can also select from among a list of affiliated golf courses to be used as preferred or default courses when booking tee times.

Once the user is logged in, they are directed to a home screen 1110. The home screen 1110 is essentially a dashboard that provides useful information to the player and acts as a point of navigation to other aspects of the player software discussed below. It is contemplated that home screen 1110 may have different modes of operation depending on the current system state, for example, the home screen 1110 may have a “countdown mode” when the player is not actively playing and a “golf mode” when the player is actively golfing.

When a player first opens the player software 1100, the home screen 1110 defaults to the “countdown mode.” In this mode, the home screen 1110 may display the player's next-scheduled tee time(s), the expected weather condition for each tee time, pictures of the golf course, ability to view images of other courses, and advertisements for golf products and player discounts. A player can drill down on a scheduled tee time to see additional details, including the number and range of holes being played, number of players in the party, specifics about the course, and additional orders including pro-shop products (tees, balls, apparel, etc.) and food and beverage orders. The player can also begin the check-in process for a tee time from the home screen 1110 when in “countdown” mode.

In either mode, the home screen 1110 may provide communications from the golf course to the player, for example, in the form of push notifications. Such communications may include, for example: current course and weather conditions; offers, deals, and sales; upcoming events; local advertising; or product order confirmation and status. The home screen 1110 may also provide access to past notifications and may allow a player to respond to notifications or send other communications to the golf course.

From the “countdown” mode of home screen 1110, the player has several options for setting a tee time for a round of golf. For example, at step 1120, a player may set a new time at a default golf course and/or see a list of existing times for the player with the ability to edit or delete them. Alternatively, the player may be directed to a tee-time wizard 1130. The tee-time wizard 1130 allows a player to browse through a list of available tee times at different courses, including by searching for courses first and seeing a list of available times at a specific course, or using a calendar first select a date and/or time and see a list of courses with available spots at that time. The player may be able to drill down into the data on a specific course to see more information about the course, including course pictures, pricing, number of holes, hole lengths, pars, player ratings and other statistics. The player may also be able to input the number of expected golfers as a filter for the search and/or for registration of the tee time. Players may also be able to search tee times based on vehicle availability.

After the player schedules a tee time, at steps 1140 and 1142 the player can add products to their order either to be delivered at cart pickup or at another time/location, respectively. This includes reserving a vehicle and ordering golf shop products (e.g.,tees, balls, apparel, etc.) and food and beverages. Players may search products, or view lists of products by category. Players may also drill down into the data on products to view images, pricing, availability, reviews and other information.

Once the player has finished adding products, the player is directed to a checkout step 1150, which confirms the tee time and additional product information. If the player is logged in, they may be directed to select a prestored payment method to complete the transaction. If the player is not logged in, they may be directed to login or register (step 1108) to enter payment information before then being redirected back to the checkout step 1150. Once the transaction is complete, the system may display a confirmation and/or send a confirmation to the player (e.g., via text message or email) before returning back to the home screen 1110.

When the player is at the course and ready to play a scheduled tee time, from the home screen 1110, the player can advance to check-in step 1160. Once the player confirms they are checking in, the software advances to vehicle acquisition step 1162. At step 1162, the software may provide a vehicle identifier to the player (e.g., a cart number) as well as other information such as an image or description of the vehicle, operation instruction and/or a map or description of its location. Alternatively, as described below, the player may simply find an unattended vehicle and initiate the process as described below. The player software will then synchronize with the vehicle to associate it with the player and allow the player to turn the vehicle on for use.

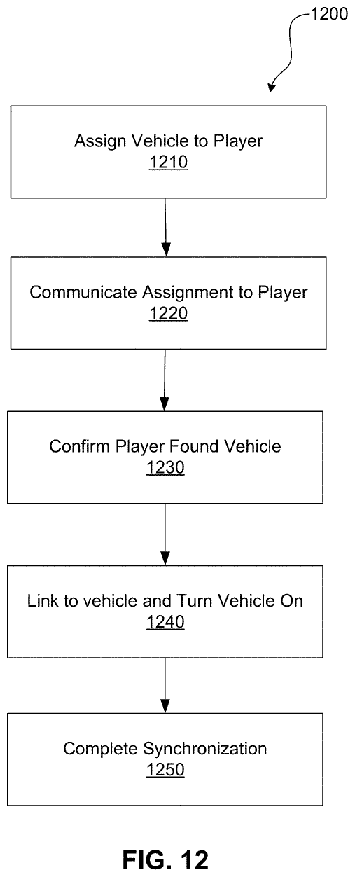

FIG. 12 shows an exemplary sub-process 1200 for synchronizing a vehicle with a player during check-in. At step 1210, the central control system will review the list of vehicles available vehicles and assign a vehicle to the player by associating the vehicle within the player data records. At step 1220, the vehicle assignment is communicated to the player through the player software 1100 by providing vehicle identification information as described above for step 1162 of the player software 1100. Once the player locates the vehicle using the information provided, at step 1230, the system confirms that the player has found the assigned vehicle. In one embodiment, the player is directed to scan code (such a QR code or other barcode) using their mobile device. As such, the player software 1100 may access a camera of the mobile device, detect the code and confirm that it matches an associated code provided by the central control system. Alternatively, the player software may transmit the scanned code to the central control system for comparison.

Once it is confirmed that the player has found the correct vehicle, at step 1240 the player software communicates with the vehicle control unit of the vehicle as described above. For example, using the short-range wireless communication described above, the player software, through the mobile device, will send a communication to the vehicle control unit causing the vehicle control unit to operate the relay to turn the vehicle on. At step 1250, the synchronization process is completed by confirming that the vehicle is operational. In some embodiments, once the vehicle is on, the vehicle control unit may respond to the mobile device and player software indicating the synchronization was successful. In other embodiments, the vehicle control unit may report directly to the central control system (via long-range wireless communication) that the vehicle has been activated as expected.

In some embodiments, there is no pre-assignment of vehicles. In such embodiments, the player may simply find an occupied vehicle, begin the check-in process through the player software and then proceed as described above (and in FIG. 12) by scanning a code on the vehicle to link the vehicle to that player. The central control system may then be informed by the player software that the scanned vehicle has been linked to the specific player.

Returning back to FIG. 11 and player software 1100, after the vehicle synchronization, the check-in process is complete and the system proceeds to a “golf mode” version of the home screen 1170. While some aspects are similar to the home screen 1110 described above, the home screen 1170 provides check-out option and provides reminders for players to checkout. The home screen 1170 may also provide players with information about course conditions and congestion, current hole information, and allow the player to enter and view scoring. The home screen 1170 may also allow a player to order food, beverages or other products to be delivered to their location (or a future location) on the course. It may also provide advertisements and deals relating to the current course.

When the player has completed their round of golf, from the “golf mode” home screen home screen 1170 they can proceed to check-out step 1180. At step 1180, the system disassociates the vehicle with the player and disables the vehicle using a similar process to that described above with reference to FIG. 12 (the vehicle may be instructed to turn off by a communication from the mobile device and player software or from the central control system). At step 1180, players may also be prompted to, or have the ability to leave feedback about the course or their playing experience. Once checkout is complete, the player software 1110 returns to the “countdown mode” home screen 1110.

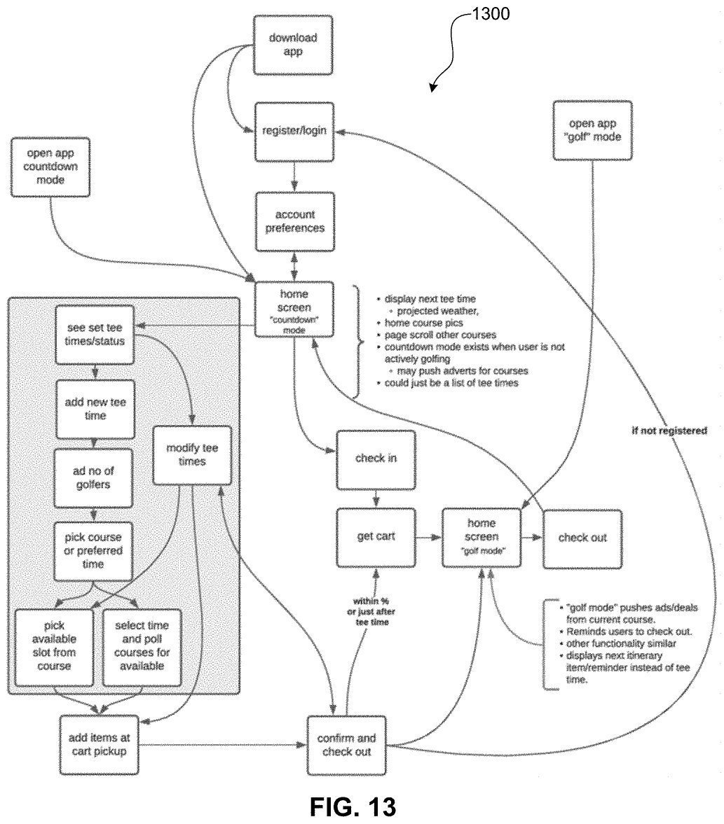

Other functionalities of the player software are contemplated. FIG. 13 shows the flow of an alternate embodiment of a player software 1300. While the order and flow of the steps is different, the process at each step is generally the same as described above for like-named steps of the exemplary player software 1100. While not shown, it is also contemplated that the player software may include a community function, including aspects such as digital games, statistics, and sharing of information among contacts or friends. The player software can also be used to facilitate tournament play. Various use cases for the invention are described below.

### Use Case 1: Account Creation

Golfer learns about the software through an online website or his golfing buddy or the head pro at his course. He downloads the software on his mobile phone from its application store and he creates an account by inputting name, address, payment information, driver's license number, email address, etc. The software asks him for relevant access to application programming interfaces (“APIs”), such as location, and payment APIs. Golfer may also enter credit card information. Golfer may also enter golf-specific information, such as USGA handicap number or favorite course.

### Use Case 2: Golfer Plays 18 Holes

On Wednesday morning, Golfer gets a notification that Augusta National is having a reduced greens fees event Wednesday from 11:00 am-2:00 pm. Golfer opens the software to the home page, opts to select a tee time and searches for Legend Lake Golf Course. She selects book a tee time and selects a tee time for 12:08 that day. She arrives at the golf course at 11:45 to warm up on the practice range.

At the course, Golfer opens the software, clicks the check-in button, finds the golf cart listed as assigned to her and uses her phone to connect to the golf cart. She receives a notification that she is checked in for her 12:08 tee time. She sees the current prices for 9 holes, 18 holes and whether incomplete rounds are currently available. She proceeds to the practice area and receives a notification on her phone when she is next up on the tee.

Golfer then plays 18 holes. After playing, she returns the cart to the parking area, opens her app and checks out. Her account is charged the current rate for 18 holes.

### Use Case 3: Golfer Plays 6 Holes

On Wednesday morning, Golfer decides he will be able to play 6 holes of golf at lunch. He opens the player software and sees that the next available tee time is 12:16 pm. He heads to Legend Lake at 11:45 am, finds an unoccupied golfcart and checks in through the software to link to and turn on the cart. Golfer receives a notification that he is checked in for his 12:16 pm tee time. He sees the current prices for 9 holes, 18 holes and whether incomplete rounds are currently available. He sees that he can play 6, 9, 12, 15 or 18 holes. He heads to the practice range and then receives a notification from the player software when he is next up on the tee.

Golfer plays 6 holes and returns to the golfcart parking area and checks out through the player software. His account is charged for the price of playing 6 holes.

As described herein, when one or more components are described as being connected, joined, affixed, coupled, attached, or otherwise interconnected, such interconnection may be direct as between the components or may be indirect such as through the use of one or more intermediary components. While the present invention has been illustrated by the description of embodiments thereof, and while the embodiments have been described in considerable detail, it is not the intention of the applicants to restrict or in any way limit the scope of the invention to such details. Additional advantages and modifications will readily appear to those skilled in the art. Therefore, the inventive concept, in its broader aspects, is not limited to the specific details, the representative apparatus, and illustrative examples shown and described. Accordingly, departures may be made from such details without departing from the spirit or scope of the applicant's general inventive concept.

We claim:

1. A golf course and vehicle administration system, comprising:
A player software application installed on a mobile device of a player;
A central control system having
a central control server,
at least one database with golf course, vehicle and player information stored thereupon, and
a first long-range wireless communication module,
wherein the central control server is in data communication with the player software application via the mobile device over the internet;
a vehicle control unit connected to a vehicle, the vehicle control unit having
a second long-range wireless communication module configured to communicate with the central control system,
a short-range wireless communication module configured to communicate with the player software via the mobile device, and
a relay configured to activate the vehicle;
wherein the player software application is configured to send a short-range wireless communication to the vehicle control unit that activates the vehicle; and
wherein the player software application is configured to, after activation of a vehicle, transmit confirmation of the activation to the central control system to link the player with the vehicle.

2. The system of clam 1, wherein
the vehicle further comprises a code affixed thereupon;
the vehicle information stored in the at least one database includes data relating to the code; and
the player software application is further configured to capture the code and only send the short-range wireless communication to the vehicle control unit that activates the vehicle upon confirmation that the affixed code is related to the stored data relating to the code.

3. The system of claim 1, wherein the vehicle control unit further comprises a satellite positioning module configured to detect a geolocation of the vehicle, and the vehicle control unit is configured to transmit the geolocation of the vehicle to the central control system.

4. The system of claim 3, wherein the vehicle control unit is configured to record a first geolocation at a first time and a second geolocation at a second time, and wherein the vehicle control unit determines whether to transmit the geolocation of the vehicle to the central control system based on a difference between the first and second time and a difference between the first and second geolocation.

5. The system of claim 3, wherein the central control system further comprises
a terminal having a display;
wherein the central control server is configured to display a map of the golf course via the display; and
wherein the central control server is further configured to display a geolocation transmitted from a vehicle relative to the map.

6. The system of claim 1, wherein the central control server is configured to send a long-range wireless communication to the vehicle control unit that deactivates the vehicle.

7. The system of claim 1, wherein the player software application comprises an interface for booking a particular tee time at the golf course.

8. The system of claim 7, wherein the interface for booking a particular tee time at the golf course includes an interface for booking less than 18 holes of golf.

9. The system of claim 1, wherein the player software application comprises an interface for checking in to a booked tee time at the golf course.

10. A method for controlling a vehicle on a golf course comprising:
connecting a vehicle control unit to the vehicle, the vehicle control unit having
a long-range wireless communication module configured to communicate with a central control system,
a short-range wireless communication module configured to communicate with a player software application installed on a mobile device, and
a relay configured to activate the vehicle;
receiving, from the player software, via short-range wireless communication, a request to activate the vehicle;
in response to the request, controlling the relay to activate the vehicle; and
transmitting, to the central control system, via long-range wireless communication, data indicating that the vehicle has been activated.

11. The method of claim 10, wherein the vehicle control unit further comprises a satellite positioning module configured to detect a first geolocation of the vehicle at a first time, the method further comprising transmitting the first geolocation of the vehicle to the central control system.

12. The method of claim 11, further comprising:
recording the first geolocation of the vehicle and the first time;
detecting a second geolocation of the vehicle at a second time; and
determining whether to transmit the second geolocation of the vehicle to the central control system based on a difference between the first and second time and a difference between the first and second geolocation.

13. The method of claim 10, further comprising:
receiving, from the central control system, via long-range wireless communication, a request to deactivate the vehicle;
in response to the request to deactivate, controlling the relay to deactivate the vehicle.

14. A method of managing a golf course and vehicles therein, the method comprising:
receiving, via the internet, and from a player software application installed on a mobile device of a player
a request to register the player,
a request to book a specific tee time, and
a request to check in for the specific tee time;
transmitting, via the internet, and to the player software application, an instruction to activate a specific vehicle on the golf course; and
receiving, via long-range wireless communication, from a vehicle control until connected to the vehicle, confirmation that the vehicle was activated;

15. The method of claim 14, further comprising:
receiving, via the internet, and from the player software application, a request for the player to check out; and
transmitting, via long-range wireless communication, to the vehicle control unit, a command to deactivate the vehicle.

16. The method of claim 14, further comprising, prior to transmitting the instruction to activate the specific vehicle on the golf course:
storing vehicle information in a database, including data relating to a code affixed upon the vehicle;
receiving, via the internet, and from the player software application, the code affixed upon the vehicle as captured by player software application;
comparing the code received from the player software application to the stored data relating to the code and
determining whether to transmit the instruction to activate the specific vehicle on the golf course based on the comparison.

17. The method of claim 14, further comprising:
storing vehicle information in a database, including data relating to the specific vehicle;
storing data relating to the player in the database after receiving the request to register the player;
after receiving confirmation that the vehicle was activated, linking the player and the specific vehicle in the database.

18. The method of claim 14, further comprising:
receiving geolocation data from the specific vehicle; and
displaying a map of the golf course indicating the geolocation of the specific vehicle relative to the golf course.

19. The method of claim 14, wherein the request to book a specific tee time includes a request to play less than 18 holes of golf.

20. The method of claim 14, further comprising, transmitting, via the internet, and to the player software application, a message relating to one of weather conditions, course conditions, special offers, deals, sales, upcoming events, local advertising, product order confirmation, or product order status.
